(19) United States
(12) Patent Application Publication
(10) Pub. No.: US 2001/0017645 A1
(43) Pub. Date: Aug. 30, 2001

(54) IMAGE FORMING APPARATUS

(76) Inventor: TSUNEO TODA, IWATSUKI-SHI (JP)

Correspondence Address: OLIFF & BERRIDGE PLC, P.O. BOX 19928, ALEXANDRIA, VA, 22320

(21) Appl. No.: 09/455,774

(22) Filed: Dec. 7, 1999

(30) Foreign Application Priority Data
Dec. 17, 1998 (JP) 10-359182
Nov. 18, 1999 (JP) 11-327969

(51) Int. Cl. B41J 2/385; G03G 15/01

(52) U.S. Cl. 347/116; 399/301

(57) ABSTRACT

The present invention improves the grade of an output image formed by composition of plural images in a simple and low-cost constitution. Cylindrical mirrors corresponding to the respective colors (K, Y, M, C) are respectively provided with a scanning line inclination and bend correcting mechanism. Further, the side registration, the lead registration and the scaling factor are corrected by controlling the modulation timing of a laser beam corresponding to each color. The color aberration caused by the change in the ambient environment is corrected by detecting a variation in the positional relationship between the respective beams by a main scanning position detecting sensor and a sub-scanning position detecting sensor provided by each color to be reflected in the control for the modulation timing.

### FIELD OF THE INVENTION

1. Field of the Invention

The present invention relates to an image forming apparatus and particularly to an image forming apparatus adapted to output plural images formed on a photoreceptor by respectively scanning plural light beams on the photoreceptor as a single composite image such as a color image or the like by composition.

2. Description of the Related Art

An image forming apparatus adapted to form an electrostatic latent image by scanning a light beam modulated according to an image to be formed on a photoreceptor and form an image on the photoreceptor has been used in equipment such as a printer, a copying machine or the like heretofore. Recently, however, since such equipment has been digitized or enabled to generate color output, the image forming apparatus of the described constitution has been used widely. The formation of a color image can be implemented by sequentially forming images of the respective colors on the photoreceptor in such a manner that the images of four different colors (e.g. C, M, Y, K), for example, are superposed on the single photoreceptor. Such formation, however, has the problem that it takes much time until a color image is finally formed.

Therefore, a so-called tandem image forming apparatus is devised in which plural photoreceptors are provided, the respective photoreceptors are simultaneously scanned to be exposed by plural light beams to form images of different colors on the photoreceptors, respectively, and the images of the respective colors are superposed on the same transfer medium to form a color image. The tandem image forming apparatus is adapted to simultaneously form the image of the respective colors, so that the time required for forming a color image can be remarkably reduced.

In the tandem image forming apparatus, however, in the case where registration for the respective light beams is not performed, a high grade color image cannot be obtained because of variation in optical characteristics of the respective light beams corresponding to the images of the respective colors. As items requiring registration, there are following five items: (1) the writing position of a scanning line in the main scanning direction (hereinafter referred to as side registration); (2) the writing position of a scanning line in the sub-scanning direction (hereinafter, referred to as lead registration); (3) the writing end position of a scanning line in the sub-scanning direction or the recording range length in the main scanning direction (hereinafter referred to as a scaling factor; (4) the bend of a scanning line itself (hereinafter referred to as a scanning line bend); and (5) the inclination of a scanning line. A high grade color image can be obtained only when registration is performed concerning each of the five items.

The constitution of the tandem color image forming apparatus is divided broadly into two main groups according to the configuration of an exposure unit. One of two kinds of configurations is such that four units including a light source for emitting a light beam, a deflecting unit having a polygon mirror for deflecting a light beam and a motor, and a scanning optical system such as an fθ lens or the like are arranged (4-motor 4-beam scanning device) . This arrangement has the problems that since individual light beams are deflected by separate deflecting units, it is necessary to provide the same number of motors for driving the deflecting units in rotation as the number of light beams, and that to perform alignment concerning each of the five items, it is necessary to provide a special mechanism for controlling the phase of rotation of the individual motors.

The other of the described two configurations is, as disclosed in Japanese Published Unexamined Patent Application No. Hei 3-142412, such that four light beams are respectively deflected by a single deflecting element(l-motor 4-beam scanning device). This configuration has the advantage that since it is sufficient to provide one motor for driving the deflecting unit in rotation, the image forming apparatus can be easily reduced in size and the cost can be brought down to the minimum, and furthermore, it is not necessary to provide a special mechanism for controlling the phase of rotation of the motor.

The color registration in the color image forming apparatus will now be described. In the tandem color image forming apparatus, it is necessary to correct the side registration, the lead registration, the scaling factor, the bend of a scanning line and the inclination of a scanning line to register. For example, in Japanese Published Unexamined Patent Application No. Hei 2-291573, in the case of transferring the respective images formed on each photoreceptor to a transfer belt to be superposed, before image formation, test toner images of the respective colors are formed on the photoreceptor and transferred to the transfer belt, and the color aberration amount is detected by reading the test toner images by a read sensor to correct the writing start position in the main scanning direction, the scanning line scaling factor and the lens characteristics.

According to this method, in correcting the writing start position, the color aberration amount is calculated according to the output from a read sensor for reading a test toner image, and the delay amount from a scanning beam detecting unit as a reference for positioning a scanning beam is controlled to determine the writing position. In correcting the scaling factor, the frequency of an image clock used in image formation is varied to determine the writing end position. Further, concerning the misregistration due to the lens characteristics, the lens is moved by an actuator to make correction.

As other correction for color aberration, Japanese Published Unexamined Patent Application No. Hei 3-142412 discloses a correction method for the inclination of a scanning line. To be concrete, a register mark is exposed on each photoreceptor by a beam of each color and developed to form a register mark image on a transfer medium, the register mark is read by a read sensor provided on the transfer medium to detect color aberration, and according to the output result, a reflecting mirror in a scanning device is moved by an actuator to correct the inclination of a scanning line.

In the tandem color image forming apparatus, it is essential to periodically execute the correction for color aberration to obtain a high grade color image. In any case of the related art, a test image for color registration is formed on a transfer medium, and the color aberration amount is detected by a read sensor. In this case, the correcting accuracy for color aberration depends on the accuracy of detecting color aberration amount by a read sensor. For example, in the case of 600 SPI (Spots Per Inch: the number of light spots per inch) which is a general image write density in a recent image forming apparatus, resolving power of at least 42.3 [μm] or less is needed for as the accuracy required for color registration, and in order to read with this resolving power, an expensive CCD is frequently used as a read sensor. However, higher resolution for an image is expected to further develop in the future, and the resolving power required of the read sensor is expected to become more exact.

Further, as a control method for a light beam, a lens and a reflecting mirror or the like in an exposure device are controlled by an actuator or the like, so that a unit that implements the function required for color registration is expensive. With a further development in high resolution of an image, there is high possibility that the level of demand for control accuracy becomes higher.

### SUMMARY OF THE INVENTION

The invention has been proposed in consideration of the above facts, and accordingly, provides an image forming apparatus which can implement an improvement in grade of an output image formed by composition of plural images in a simple and low-cost constitution.

According to an aspect of the present invention, the image forming apparatus, which has plural photoreceptors, and is adapted to form images on the respective photoreceptors by scanning the photoreceptors with plural light beams, respectively, and sequentially transfer the plural images to a transfer body in such a manner that the plural images formed on the respective photoreceptors are superposed one another to form a single image on the transfer body, includes at least two compensating units from among a first compensating unit that compensates for a relative misregistration of the plural images on the transfer body in the light beam scanning direction, a second compensating unit that compensates for a relative misregistration of the plural images on the transfer body in the direction intersecting the scanning direction, a third compensating unit that compensates for a difference in relative size between plural images on the transfer body in the scanning direction, a fourth compensating unit that compensates for relative inclination of scanning loci of light beams on the transfer body, and a fifth compensating unit for compensating for a relative bend of scanning loci of light beams on the transfer body.

The image forming apparatus is adapted to output a composite image of plural images formed on a photoreceptor by scanning plural light beams respectively on the photoreceptor. Thus, for example, in the case where plural images are images of different colors, an output image output by composition of plural images is a multi-color image (letting the colors of plural images be K, Y, M, C, it is a full color image). The number of photoreceptors may be one or plural, but preferably plural photoreceptors are provided and images are formed on the respective photoreceptors at the same time by plural light beams (tandem system), whereby the amount of time until a composite image is finally output can be reduced. Further, one or plural deflecting units are needed to scan a light beam on the photoreceptor, but preferably, plural light beams are deflected by a single deflecting unit, whereby the apparatus can be reduced in size and a complicated mechanism for controlling the phase of rotation of the motor is not needed.

The image forming apparatus may have an adjusting unit capable of adjusting the relative inclination and the bent of a scanning locus of a light beam on the photoreceptor in units of the respective light beams, whereby according to the finish state of an image output by composition of plural images in the image forming apparatus, for example, the relative inclination and the bend of the scanning locus can be corrected through the adjusting unit for each light beam. In the course of manufacturing an image forming apparatus, the relative inclination and the bend of a scanning locus are measured by a measuring device, and according to the measurement result, the relative inclination and the bend of the scanning locus can be corrected. Thus, the relative misregistration (in the case where an output image is a color image, the misregistration is visually recognized as color aberration) of plural images caused by the relative inclination of the scanning locus or the relative bend of the scanning locus can be eliminated.

Further, the apparatus may also have a storage unit storing the modulation start time within the period of one scan of each light beam set in such a manner that the relative misregistration of plural images in the light beam scanning direction is corrected, the modulation start time taking one scan of each light beam as a unit set in such a manner that the relative misregistration of plural images in the direction intersecting the scanning direction is corrected, and the length of modulation time within the period of one scan of each light beam set in such a manner that a difference in sizes of plural images in the scanning direction is corrected.

The modulation start time within the period of one scan of each light beam, the modulation start time taking one scan of each light beam as a unit, and the length of modulation time within the period of one scan of each light beam can also be set according to the finish state of an image output by composition of plural images in the image forming apparatus. The control unit controls the modulation of each light beam in the modulation timing according to the modulation start time and the length of modulation time stored in the storage unit, so that the relative misregistration of plural images caused by misregistration of the side registration, the lead registration and scaling factor of each light beam can also be eliminated so as to obtain a high grade output image.

Here, when the arrangement positions of the respective optical parts existing on an optical path of a light beam reaching a photoreceptor from a light source of a light beam vary due to a change in surrounding conditions of an image forming apparatus, the positional relationship between the light beams is varied to cause the relative misregistration of plural images, resulting in the possibility of lowering the grade of an output image.

To counter this, the apparatus according to the present invention may also have a detecting unit for detecting the variation of the positional relationship between the light beams, whereby according to the variation of the positional relationship between the light beams detected by the detecting unit, the correcting unit corrects the modulation timing of each light beam, so that the relative misregistration of plural images caused by the variation of the positional relationship between the light beams can be eliminated so as to keep the grade of an output image.

The positional relationship between the light beams is, for example, detected by a passing detecting unit held in the detecting unit for detecting the passing of a light beam in a designated position within the light beam scanning range concerning the respective light beams, or a position detecting unit for detecting the position of the scanning position of each light beam in the direction intersecting the scanning direction of the light beam, and these detecting units can be formed by a simple photo detecting element such as an optical switch or a photo sensor. An expensive sensor such as CCD or the like is not needed. Thus, the improvement in grade of an output image formed by composition of plural images can be implemented in a simple and low-cost constitution according to the present invention.

According to another aspect of the present invention, the apparatus may further have a setting unit for setting the modulation start time within the period of one scan of each light beam in the storage unit in such a manner that the relative misregistration of the plural images in the light beam scanning direction is corrected, setting the modulation start time taking one scan of each light beam as a unit in the storage unit in such a manner that the relative misregistration of plural images in the direction intersecting the scanning direction is corrected, and setting the length of modulation time within the period of one scan of each light beam in the storage unit in such a manner that a difference in relative size of plural images in the scanning direction is corrected.

The modulation start time and the length of modulation can be set in the storage unit by the setting unit. Further, an image output by composition of plural images in the image forming apparatus of the present invention is checked to obtain the optimum values according to the state of each part of the current image forming apparatus as the modulation start time within the period of one scan of each light beam, the modulation start time taking one scan of each light beam as a unit, and the length of modulation time within the period of one scan of each light beam, and the obtained values can be again set in the storage unit by the setting unit. Accordingly, even in the case where the installation environment for the image forming apparatus is changed remarkably, the lowering of grade of an output image can be avoided.

As the setting unit, it is possible to use an information input unit such as a ten key, or a keyboard, or an information processing unit having an information input function such as a personal computer or the like. The setting unit may be integrated with an image forming apparatus of the present invention, or be separated to be portable.

On the other hand, the detecting unit has the passing detecting unit for detecting the passing of a light beam in a designated position within the light beam scanning range concerning the respective light beams, and a position detecting unit for detecting the scanning position of each light beam in the direction intersecting the scanning direction of the light beam, wherein according to the timing of detecting the passing of each light beam by the passing detecting unit, the positional relationship between the light beams in the scanning direction can be detected, and according to the scanning position of each light beam detected by the position detecting unit, the positional relationship between the light beams in the direction intersecting the scanning direction can be detected.

The detection for variations in positional relationship by the detecting unit is, to be more precise, such that the positional relationship between the light beams is detected and stored, the positional relationship between the light beams is detected, and the detected positional relationship is compared with the stored positional relationship to detect a variation in the positional relationship. Thus, the variations in positional relationship can be quantitatively detected. The detection, storage and comparison for the positional relationship are also preferably performed separated between the scanning direction of the light beam and the direction intersecting the scanning direction.

In the apparatus according to the present invention, the detecting unit detects variations in positional relationship between plural light beams in the scanning direction of the light beam and in the direction intersecting the scanning direction, respectively, and in the case where a variation in positional relationship between the light beams in the scanning direction is detected, the correcting unit corrects the modulation start time within the period of one scan of each light beam, and corrects the modulation start time taking one scan of each light beam as a unit in the case where a variation in positional relationship between the light beams in the direction intersecting the scanning direction is detected.

In the apparatus, the positional relationship between the light beams is detected in the scanning direction of the light beam and in the direction intersecting the scanning direction, respectively, whereby the correcting unit can easily correct the modulation timing of each light beam according to the variation in the positional relationship between the light beams.

The modulation start time within the period of one scan of each light beam is, to be concrete, expressed by a first preset value for regulating the modulation start time within the period of one scan of each light beam on the basis of timing of the passing of a specified light beam through a designated position within the light beam scanning range. Similarly, the modulation start time taking one scan of each light beam as a unit is expressed by a second set value for regulating the modulation start time taking one scan of each light beam as a unit on the basis of a designated timing, and the length of modulation time within the period of one scan of each light beam is expressed by a third set value for regulating the length of modulation time within the period of one scan by the frequency of a clock signal showing the modulation timing of a light beam within the period of one scan.

In this case, the first set value, the second set value and the third set value are stored in the storage unit, the control unit controls the modulation of each light beam according to the first to third set values stored in the storage unit, and the correcting unit corrects at least either the first set value or the second set value according to the detected variation in positional relationship between the light beams.

Since the first set value is the data for regulating the modulation start time of each beam on the basis of timing when a specified light beam passes through a designated position within the light beam scanning range, concerning a sensor for detecting light beams other than the specified beam, it is not necessary to determine the arrangement position on the condition that the modulation start time of the light beam is determined on the basis of the time when the light beam is detected. Accordingly, obtained is the effect of improving the degree of freedom of arrangement position of the sensor for detecting the light beams other than the specified light beam.

The adjusting unit of the present invention may be formed by an actuator or the like to periodically or automatically adjust the inclination and the bent of a scanning locus of a light beam on a photoreceptor, but in the normal environment, once the degree of the inclination and the bend of a scanning locus of a light beam is adjusted, it hardly changes. Further, it is confirmed by the inventor of the patent application that, by the improvement in layout of a scanning optical system of an image forming apparatus or the improvement in dimensional accuracy of each optical part forming the scanning optical system, the change (the sensitivity to the variation of the factor) in degree of the inclination and the bend of a scanning locus of a light beam to the variation of a factor which influences the degree of the inclination and the bend of a scanning locus of a light beam becomes smaller.

Therefore, the adjusting unit of the present invention is preferably a manual adjusting mechanism constructed so that when the stress is applied in a designated direction, the stress is transmitted to designated optical parts forming a scanning optical system for a light beam as the force for displacing the designated optical parts to vary the degree of the inclination or the bend of a scanning locus of a light beam. As the manual adjusting mechanism, to be concrete, a well-known stress transmitting unit such as a screw, a cam, a link or the like can be used. Thus, as compared with the case where the adjusting unit is formed by an actuator or the like, the constitution of an image forming apparatus can be simplified and the cost reduction can be realized.

According to another aspect of the present invention, the image forming apparatus has a scanner with a light source for emitting the respect light beams, a deflecting unit for deflecting each light beam in such a manner that each light beam scans on a photoreceptor, and a scanning optical system for guiding each deflected light beam to the photoreceptor accommodated in a storing box to be concealed from the outside, the setting unit is capable of setting the modulation start time within the period of one scan of each light beam, the modulation start time taking one scan of each light beam as a unit, and the length of modulation time within the period of one scan of each light beam in the storage unit, and the adjusting unit is capable of adjusting the inclination and the bend of a scanning locus of a light beam on the photoreceptor.

The scanner is accommodated in the storing box to be concealed from the outside, the setting unit is capable of setting the respective parameters (modulation start time and length of modulation time) and the adjusting unit is capable of adjusting the inclination and the bend of a scanning locus of a light beam on the photoreceptor, so that also in the case of setting the respective parameters through the setting unit concerning the side registration, the lead registration, the scaling factor and the bend of a scanning line, or adjusting the same by the adjusting unit, it is not necessary to remove a cover of the storing box to expose the scanner.

In the case where the adjusting unit is taken as the manual adjusting mechanism, at least a driven part of the manual adjusting mechanism for manually applying the stress in a designated direction may be disposed outside the storing box (the stress transmitting part for transmitting the stress applied to the driven part to designated optical parts as the force for displacing designated optical parts to change the degree of the inclination and the bend of a scanning locus of a light beam , and the designated optical parts may be disposed outside the storing box).

### BRIEF DESCRIPTION OF THE DRAWINGS

A preferred embodiment of an image forming apparatus according to the present invention will be described in detail based on the drawings:

FIG. 1 is a schematic block diagram of a color image forming apparatus (and a plural beam scanner) according to an embodiment of the present invention;

FIG. 2 is a schematic plan view of the plural beam scanner;

FIG. 3 is a perspective view of the plural beam scanner showing a cover of a casing with portions broken away;

FIG. 4 is a schematic plan view showing the arrangement of the respective sensors on a sensor substrate;

FIG. 5A is a perspective view showing the outline of a sub-scanning position detecting sensor;

FIG. 5B is an equivalent circuit of the sensor;

FIG. 5C is a block diagram showing an example of a signal processing circuit of the sensor;

FIG. 7 is a sectional view showing the support structure of a holder on one end side;

FIG. 8A is a diagram for explaining the correction for the inclination of a scanning locus of a laser beam by displaying the end of a cylindrical mirror;

FIG. 8B is a diagram for explaining the correction for the bend of a scanning locus of a laser beam by bending the cylindrical mirror;

FIG. 9 is a schematic block diagram of a control system for controlling the operation of the plural beam scanner;

FIG. 10 is a schematic block diagram of a write timing control circuit;

FIG. 11A is a schematic block diagram of a video clock generator;

FIG. 11B is a conceptual drawing for explaining the correction for the frequency of a video clock signal;

FIGS. 12A and 12B are timing charts of a line synchronous signal and a signal related to the generation thereof;

FIGS. 13A and 13B are timing charts of a page synchronous signal and a signal related to the generation thereof;

FIG. 14 is a flowchart showing the contents of color aberration initial correction processing executed in loading an image forming apparatus with a plural beam scanner, or in the case where, during the operation of the image forming apparatus, deterioration of an image is confirmed;

FIG. 15 is a flowchart showing the contents of an automatic color aberration correction processing executed during the operation of the image forming apparatus; and

FIG. 16A is a timing chart for explaining the side registration correction according to the output of a main scanning position detecting sensor; and

FIG. 16B is a diagram showing an example of main scanning color aberration in image.

### DESCRIPTION OF THE PREFERRED EMBODIMENT

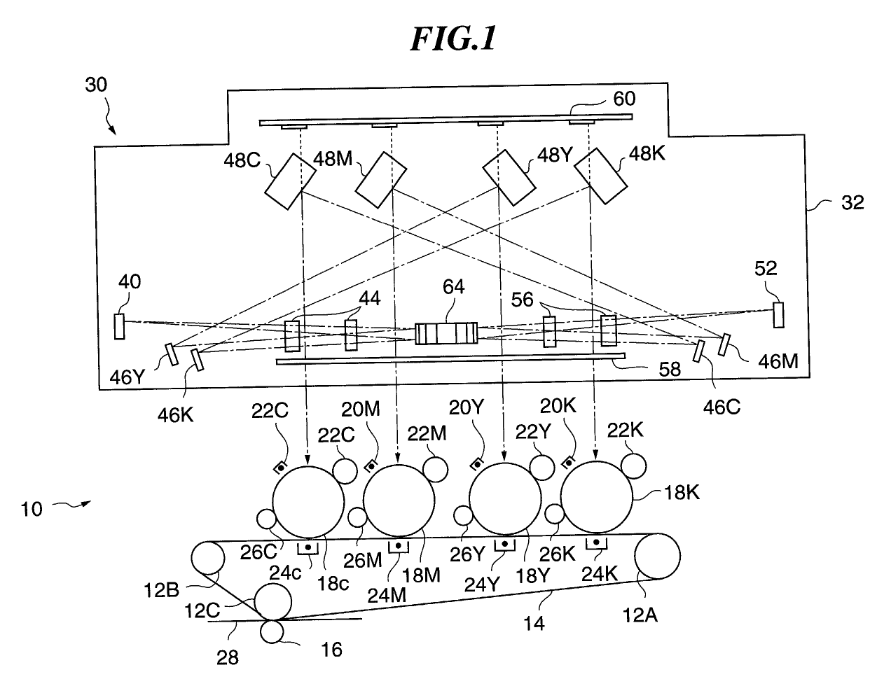

One embodiment of the present invention will now be described with reference to the attached drawings. FIG. 1 shows a color image forming apparatus 10 as an image forming apparatus of the present invention. The color image forming apparatus 10 includes three transport rollers 12A to 12C, an endless transfer belt 14 wrapped round the transport rollers 12A to 12C, and a transfer roller 16 disposed opposite to the transport roller 12C with the transfer belt 14 interposed between them.

A black (K) image forming photoreceptor drum 18K, a yellow (Y) image forming photoreceptor drum 18Y, a Magenta (M) image forming photoreceptor 18M, and a Cyan (C) image forming photoreceptor 18C are arranged substantially equal spaces in the moving direction (direction of an arrow A in FIG. 1) of the transfer belt 14 when the transfer belt 14 is driven in rotation above the transfer belt 14. Each photoreceptor drum 18 is disposed with its axis intersecting perpendicularly to the moving direction of the transfer belt 14.

In the following, the parts provided for each color K, Y, M, C are designated and distinguished by attaching the symbols K/Y/M/C to the reference numerals of the respective parts similarly to the above.

A charger 20 for charging the photoreceptor drum 18 is disposed in the periphery of each photoreceptor drum 18, and a plural beam scanner 30 (to be mentioned later in detail) adapted to radiate a laser beam to the charged photoreceptor drum 18 to form an electrostatic latent image on the photoreceptor drum 18 is arranged above each photoreceptor 18.

Further, a developing device 22 for developing an electrostatic latent image formed on the photoreceptor drum 18 with toner of a designated color (K, Y, M or C) to form a toner image, a transfer device 24 for transferring the toner image formed on the photoreceptor 18 to the transfer belt 14, and a cleaning device 26 for removing residual toner on the photoreceptor drum 18 are sequentially arranged on the downstream side of the laser beam radiating position in the rotating direction of the photoreceptor drum 18 in the periphery of each photoreceptor 18.

Toner images of different colors formed on the respective photoreceptor drums 18 are respectively transferred to the transfer belt 14 to be superposed on one another on the belt surface of the transfer belt 14. Thus, a color toner image is formed on the transfer belt 14, and the formed color toner image is transferred to a transfer material 28 fed in between the transport roller 12C and the transfer roller 16. Then, the transfer material 28 is fed into a fixing device not shown to fix the transferred toner image. Thus, a color image (full color image) is formed on the transfer material 28.

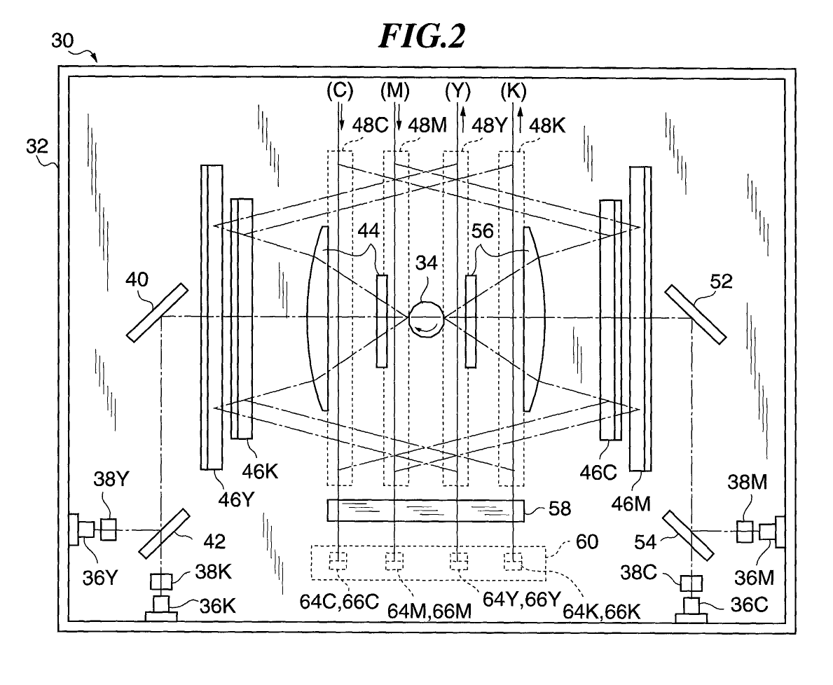

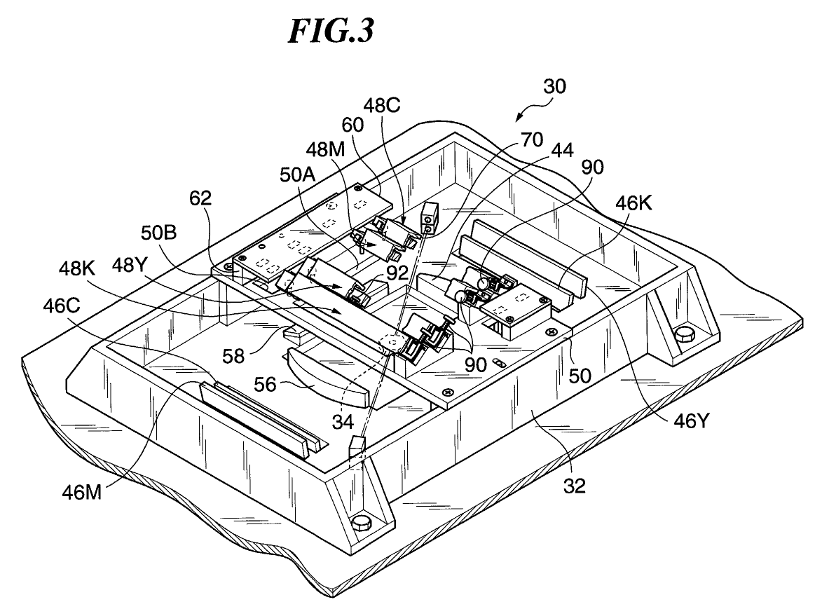

The plural beam scanner 30 will now be described with reference to FIGS. 1 and 2. The plural beam scanner 30 includes a casing 32 having a substantially rectangular bottom (corresponds to a storing box described in claim 8, also see FIG. 3), and a rotary polygon mirror 34 (corresponds to a deflecting unit described in claim 8) rotated at high speed by a motor not shown is arranged in the substantially central part of the casing 32. A semiconductor laser (corresponds to a light source described in claim 8: hereinafter referred to as LD) 36K for emitting a laser for radiation to the photoreceptor drum 18K, and an LD 36Y for emitting a laser for radiation to the photoreceptor drum 18Y are disposed near the corner at one end of the casing 32 in the direction intersecting perpendicularly to the axis of the rotary polygon mirror 34.

A collimator lens 38K and a plane mirror 40 are in order disposed on the laser emission side of the LD 36K. A laser beam K emitted from the LD 36K is made into a parallel pencil of rays by the collimator lens 38K to be incident on the plane mirror 40. Further, a collimator lens 38Y and a plane mirror 42 are in order arranged on the laser emission side of the LD 36Y, and a laser beam Y emitted from the LD 36Y is made into a parallel pencil of rays by the collimator lens 38Y and then reflected by the plane mirror 42 to be incident on the plane mirror 40.

An fθ lens 44 is disposed between the plane mirror 40 and the rotary polygon mirror 34, and the laser beam K and the laser beam Y reflected by the plane mirror 40 are transmitted through the fθ lens 44 to be incident on the rotary polygon mirror 34, and reflected and deflected by the rotary polygon mirror 34 to be again transmitted through the fθ lens 44 (so-called double path construction: see FIG. 1).

The LD 36k and the LD 36Y differ in position in the axial direction (corresponding to the sub-scanning direction) of the rotary polygon mirror 34, and the laser beam K and the laser beam Y are respectively incident on the rotary polygon mirror 34 at different angles of incidence in the sub-scanning direction, so that the laser beams K and Y transmitted through the fθ lens 44 twice are separately incident on the plane mirrors 46K, 46Y.

The laser beam K is made incident on a cylindrical mirror 48K arranged in a position corresponding to the upper side of the photoreceptor drum 18K by the plane mirror 46K, and emitted from the cylindrical mirror 48K toward the photoreceptor drum 18K to be scanned on the peripheral surface of the photoreceptor drum 18K. On the other hand, the laser beam Y is made incident on a cylindrical mirror 48Y disposed in a position corresponding to the upper side of the photoreceptor drum 18Y and emitted from the cylindrical mirror 48Y toward the photoreceptor drum 18Y to be scanned on the peripheral surface of the photoreceptor drum 18Y.

As shown in FIG. 3, the upper part of the casing 32 is all over concealed with a cover 50. A rectangular opening 50A for passing a laser beam is bored in the substantially central area of the cover 50, and the cylindrical mirrors 48K, 48Y are arranged on the upper surface of the cover 50 to stride over the opening 50A. On the other hand, an LD 36M for emitting laser for radiation to the photoreceptor drum 18M and an LD 36C for emitting a laser for radiation to the photoreceptor drum 18C are respectively disposed in the vicinity of the corner part at the end on the opposite side to the disposing positions of the LD 36K and the LD 36Y with the rotary polygon mirror 34 interposed between them in the interior of the casing 32. On the laser emission side of the LD 36C, a collimator lens 38C and a plane mirror 52 are arranged in order, and a laser beam C emitted from the LD 36C is made into a parallel pencil of rays by the collimator lens 38C to be incident on the plane mirror 52. Further, on the laser emission side of the LD 36M, a collimator lens 38M and a plane mirror 54 are arranged in order, and a laser beam M emitted from the LD 36M is made into a parallel pencil of rays by the collimator lens 38M and then reflected by the plane mirror 54 to be incident on the plane mirror 52.

An fθ lens 56 is arranged between the plane mirror 52 and the rotary polygon mirror 34, and the laser beam C and the laser beam M reflected by the plane mirror 52 are transmitted through the fθ lens 56 to be incident on the rotary polygon mirror 34, and reflected and deflected by the rotary polygon mirror 34 to be again transmitted through the fθ lens 56.

The LD 36C and the LD 36M differ in position in the axial direction (corresponding to the sub-scanning direction) of the rotary polygon mirror 34, and the laser beam C and the laser beam M are respectively incident on the rotary polygon mirror 34 at different angles of incidence in the sub-scanning direction, so that the laser beams C, M transmitted through the fθ lens 56 twice are separately incident on the plane mirrors 46C, 46M.

The laser beam C is made incident on a cylindrical mirror 48C arranged in a position corresponding to the upper side of the photoreceptor drum 18C by the plane mirror 46C, and emitted from the cylindrical mirror 48C toward the photoreceptor drum 18C to be scanned on the peripheral surface of the photoreceptor drum 18C. The laser beam M is made incident on a cylindrical mirror 48M arranged in a position corresponding to the upper side of the photoreceptor drum 18M by the plane mirror 46M, and emitted from the cylindrical mirror 48M toward the photoreceptor drum 18M to be scanned on the peripheral surface of the photoreceptor drum 18M.

It is clear from the above description that since the laser beams K, Y and the laser beams C, M are incident on the opposite surfaces of the rotary polygon mirror 34, as indicated by arrows in FIG. 2, the laser beams K, Y and the laser beams C, M are scanned in the reverse directions. Further, the cylindrical mirrors 48C, 48M are also arranged on the upper surface of the cover 50 in such a manner as to stride over the opening 50A bored in the cover 50 of the casing 32 as shown in FIG. 3.

In the vicinity of the bottom of the casing 32, a pickup mirror (plane mirror) 58 is disposed to traverse the scanning loci of the laser beams K, Y, M, C respectively reflected by the cylindrical mirrors 48K, 48Y, 48M, 48C. The pickup mirror 58 is arranged in the vicinity of the scanning start side end part (SOS: Start Of Scan) of the laser beams K, Y, that is, the scanning end side end part (EOS: End Of Scan) of the laser beams M, C in the scanning loci of the laser beams.

As shown in FIG. 3, an opening 50B for passing each laser beam which is incident on the pickup mirror 50 to be reflected is bored in the cover 50 of the casing 32, and a sensor substrate 60 is arranged in such a position as to receive the laser beam passed through the opening 50B. The sensor substrate 60 is fitted to the upper surface of the cover 50 through a bracket 62.

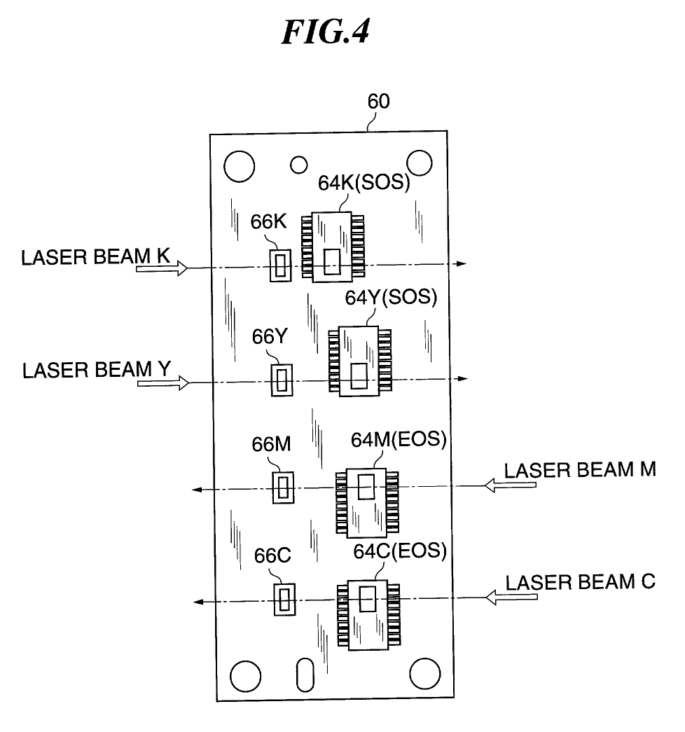

The laser beams K, Y, M, C are respectively scanned across the upper side of the sensor substrate 60 as indicated by a one-dot chain line in FIG. 4 as an example. A main scanning position detecting sensor 64 and a sub-scanning position detecting sensor 66 are respectively arranged along the scanning locus of each laser beam in the sensor substrate 60. The main scanning position sensor 64 corresponds to a passing detecting unit described in claim 3, and the sub-scanning position detecting sensor 66 to a position detecting unit described in claim 3, respectively, which forms a part of the detecting unit of the present invention. The main scanning position detecting sensor 64 is an optical sensor adapted to output signals of different levels between when a laser beam passes through a photo detecting part (a rectangular part in FIG. 4) formed on a sensor chip and when it does not so.

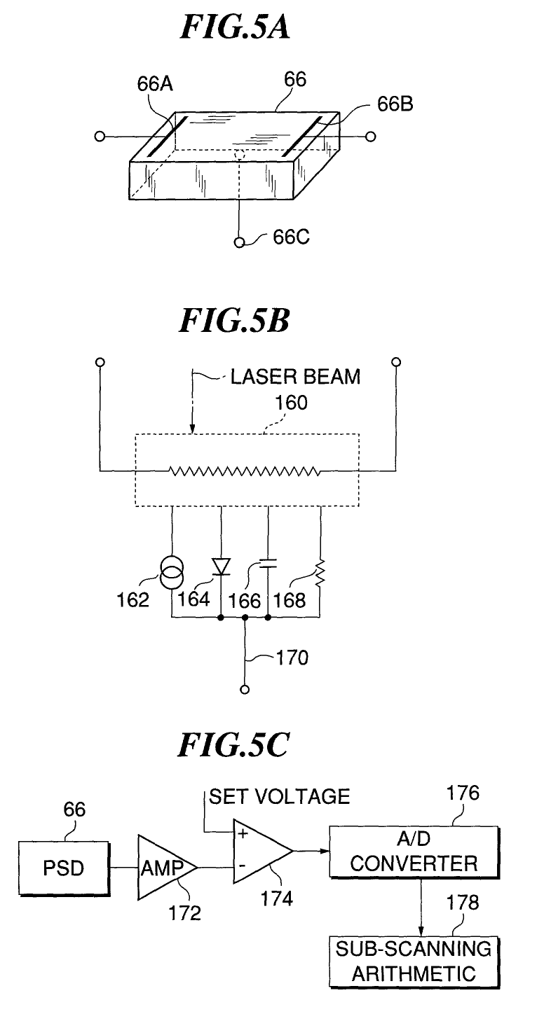

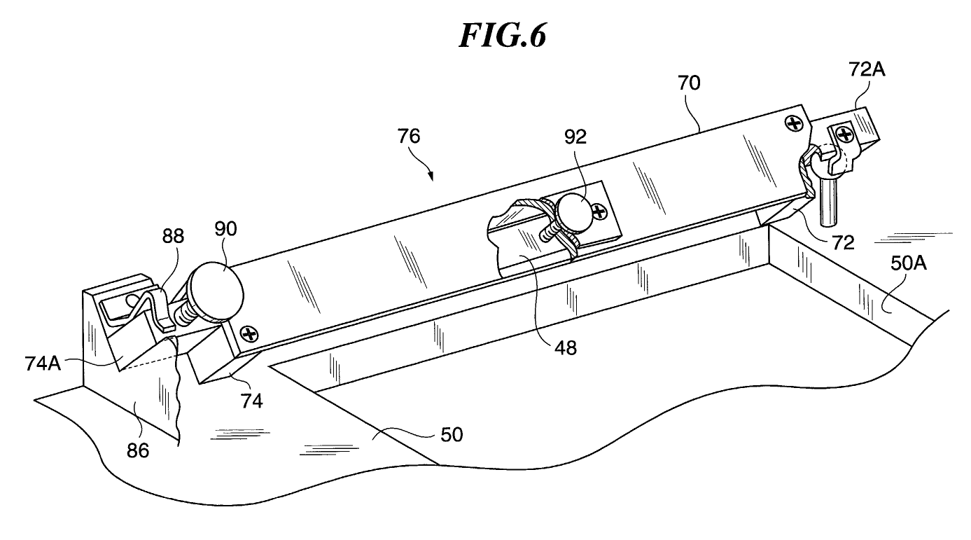

The sub-scanning position detecting sensor 66 (PSD) is, as shown in FIG. 5A, provided with electrodes 66A, 66B at both ends of an element, and a terminal 66C for applying bias voltage is connected to the sensor. As shown in FIG. 5B, an equivalent circuit is so constructed that a current source 162, a diode 164, a junction capacitance 166, and a resistance 168 are parallel connected to a positioning resistance 160 (the reference numeral 170 is bias voltage), and the incident position of the light beam can be detected by the positioning resistance 160. In the following, a detection signal output from a main scanning position detecting sensor 64K corresponding to the laser beam K is designated by “SOS (K)”, a detection signal output from a main scanning position detecting sensor 64Y corresponding to the laser beam Y is designated by “SOS(Y)”, a detection signal output from a main scanning position detecting sensor 64M corresponding to the laser beam M is designated by “EOS(M)”, and a detection signal output from a main scanning position detecting sensor 64C is designated by “EOS(C)” to be differentiated.

The sub-scanning position detecting sensor 66 detects the passing position of a laser beam in the sub-scanning direction (the longitudinal direction of the sensor substrate 60 in FIG. 4) intersecting perpendicularly to the scanning direction of the laser beam, and outputs a signal of the level corresponding to the detected passing position. In the following, a detection signal output from a sub-scanning position detecting sensor 66K corresponding to the laser beam K is designated by “PSD(K)”, a detection signal output from a sub-scanning position detecting sensor 66Y corresponding to the laser beam Y is designated by “PSD(Y)”, a detection signal output from a sub-scanning position detecting sensor 66M corresponding to the laser beam M is designated by “PSD (M)”, and a detection signal output from a sub-scanning position detecting sensor 66C is designated by “PSD(C)” to be differentiated.

In the above, the pickup mirror 58 and the sensor substrate 60 are formed in a body for the colors K, Y, M, C, but this is not restrictive. The pickup mirror and the sensor may be provided individually for each color.

The mechanism for correcting the inclination and the bend of a scanning locus of a laser beam will now be described. The mechanism is attached to each of the respective cylindrical mirrors 48K, 48Y, 48M, 48C corresponding to the respective laser beams. In the following description, the cylindrical mirror 48 is a general term for these.

As shown in FIG. 6, the cylindrical mirror 48 is held (to be precise, both longitudinal ends of the cylindrical mirror 48 are held) on a holder 76 comprising a long frame 70 having an L-shaped section (see FIG. 3), and blocks 72, 74 which are fitted to both ends of the frame 70 by screws and in which projecting parts 72A, 74A are respectively formed in the longitudinal direction of the cylindrical mirror 48.

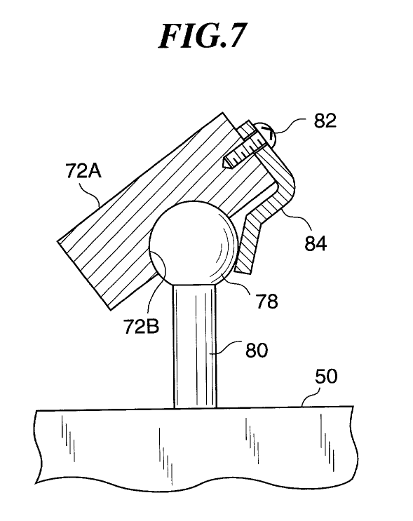

As shown in FIG. 7, a circular-arc recess 72B is formed in a projecting part 72A of the block 72, and on the upper surface of the cover 50, a shaft 80 having a steel ball 78 at the tip is erected in a position corresponding to the recess 72B of the block 72. The steel ball 78 is arranged in contact with the inner surface of the recess 72B, and clamped between a plate spring 84 fitted to the block 72 by a screw 82 and the block 72. Accordingly, the holder 76 is rotatable about the steel ball 78.

On the other hand, a support member 86 where a V-shaped groove for holding the projecting part 74A of the block 74 is formed is fixedly installed in a position of the upper surface of the cover 50 corresponding to the block 74. The projecting part 74A of the block 74 is disposed in the V-shaped groove, and pressed in the direction of approaching the base of the V-shaped groove by the energizing force of a plate spring 88 fitted to the support member 86 by a rivet. Further, a through hole is bored in the projecting part 74A of the block 74, a female screw is formed in the through hole, and an adjust screw 90 is screw-engaged therewith.

In this arrangement, in the condition where the adjust screw 90 is screwed in until the tip of the adjust screw 90 is a little projected over the projecting part 74A, the amount of projection of the adjust screw 90 over the projecting part 74A is changed in proportion to the amount of rotation of the adjust screw 90, and according to the change of the projection amount, the projecting part 74A of the block 74 is displaced in the direction corresponding to the change direction of the projection amount against the energizing force of the plate spring 88. With such displacement, the holder 76 and the cylindrical mirror 48 are turned on the steel ball 78. Thus, the inclination of a scanning locus on the photoreceptor drum 18 of a laser beam reflected by designated optical parts is changed.

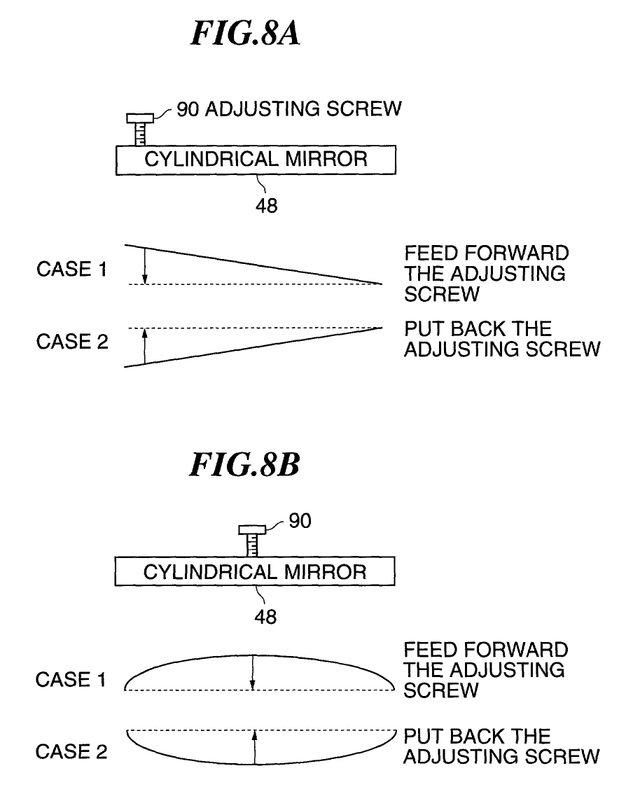

As the change direction and the change amount of the inclination of a scanning locus when the adjust screw 90 is rotated correspond to the change direction and the change amount of the projection amount of the adjust screw 90 tip, the inclination of the scanning locus of the laser beam can be corrected in any cases shown in FIG. 8A by selecting the change direction (the rotating direction of the adjust screw 90) of the adjust screw 90.

The steel ball 78, the support member 86, the plate spring 88 and the adjust screw 90 correspond together with an adjust screw 92 mentioned in the following to an adjusting unit (to be more precise, a manual adjusting mechanism described in claim 7) of the present invention, and the cylindrical mirror 48 corresponds to designated optical parts described in claim 7. A part of the adjust screw 90 (and 92) corresponding to the screw head is formed in such a manner that the peripheral surface is projected in the radial direction, this part corresponds to a driven part, and a part of the adjust screw 90 (and 92) where a male screw is formed corresponds to the stress transmitting part.

A through hole is bored in the central part in the longitudinal direction of the frame 70, a female screw is formed in the through hole, and the adjust screw 92 is screw-engaged with the female screw. The adjust screw 92 is screwed in to penetrate through the frame 70 until the tip thereof is in contact with the side surface (non-reflecting surface) of the cylindrical mirror 48. When the adjust screw 92 is rotated, the magnitude of force for pressing the side surface of the cylindrical mirror 48 by the tip of the adjust screw 92 changes with the rotating direction and the rotation amount of the adjust screw 92, and according to the change of the pressing force, the flexing amount of the cylindrical mirror 48 changes.

As the laser beam reflected by the cylindrical mirror 48 is scanned to follow the generating line of the cylindrical mirror 48, the degree of the bent of the scanning locus on the photoreceptor drum 18 is changed by changing the pressing force. As the change direction and the change amount of the bend of the scanning locus when the adjust screw 92 is rotated correspond to the change direction and the change amount of the flexing amount of the cylindrical mirror 48, that is, the change direction and the change amount of the tip position of the adjust screw 92, in any case shown in FIG. 8B, the bend of the scanning locus of the laser beam can be corrected by selecting the change direction (the rotating direction of the adjust screw 92) of the adjust screw 92 tip position.

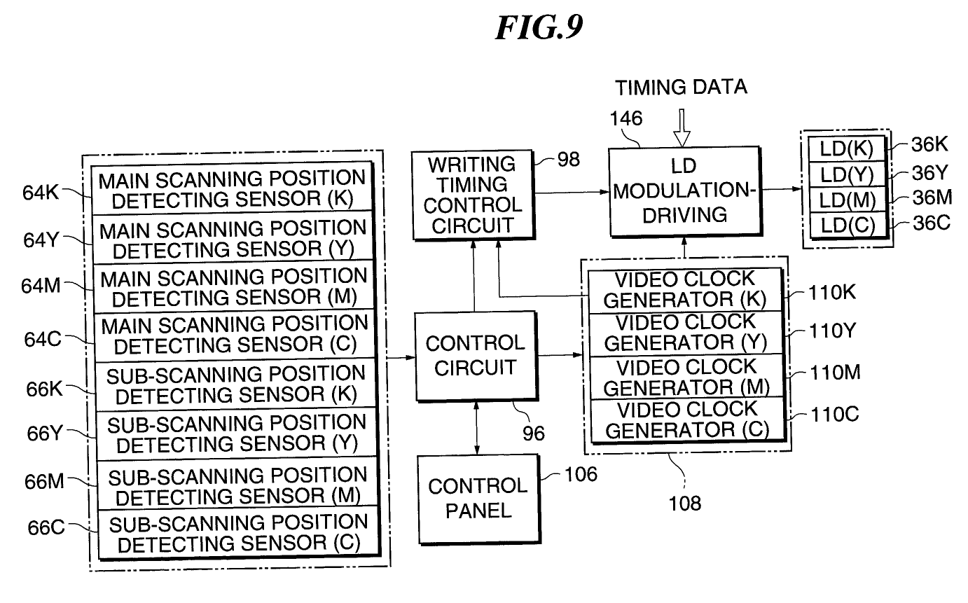

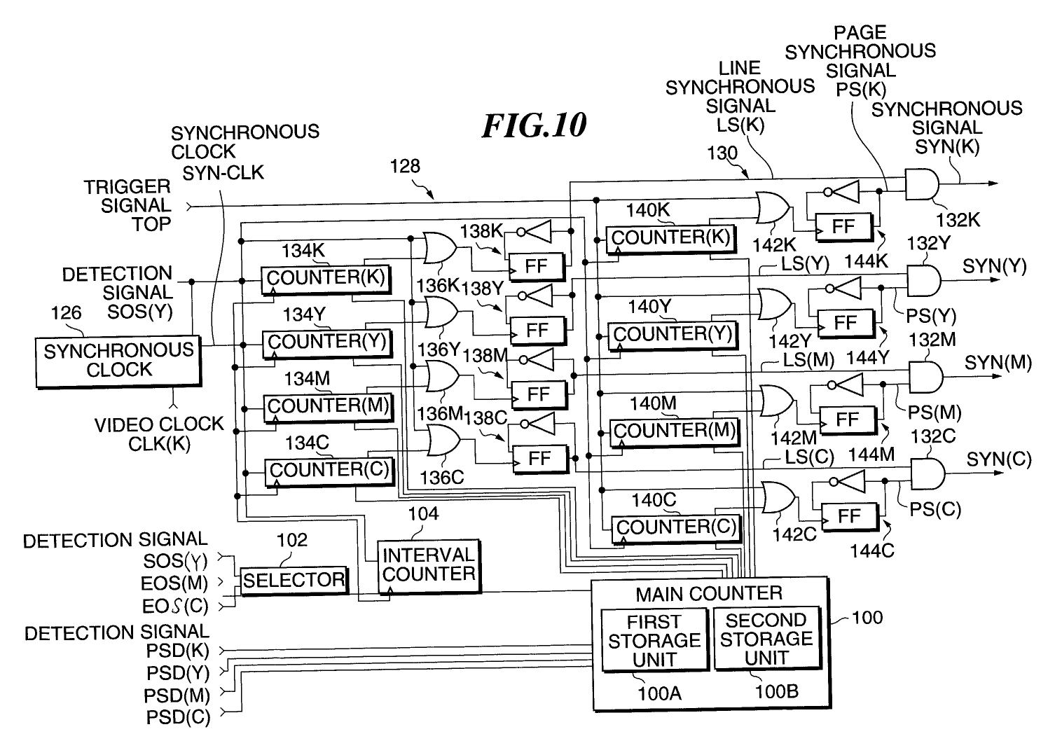

The constitution of the control system for controlling the operation of the plural beam scanner 30 including a circuit for controlling the drive of the LDs 36K, 36Y, 36M, 36C will now be described with reference to FIGS. 9 and 10. The main scanning position detecting sensor 64 and the sub-scanning position detecting sensor 66 are respectively connected to a control circuit 96, and a write timing control circuit 98 is connected to the control circuit 96. The write timing control circuit 98 corresponds to the control unit of the invention.

As shown in FIG. 10, the control circuit 96 includes a main controller 100 formed by a microprocessor or the like, and a peripheral circuit (the other circuit is not shown) of a selector 102, an interval counter 104 or the like. A control panel 106 including a display unit such as a liquid crystal display and an information input unit such as a ten-key pad or a touch panel is connected to the control circuit 96 (see FIG. 9).

Further, video clock generating device 108 is connected to the control circuit 96. The video clock generating device 108 is constructed by providing a video clock generator 110 for generating a video clock signal for regulating the modulation timing of every dot for a laser beam for each of the respective colors K, Y, M, C.

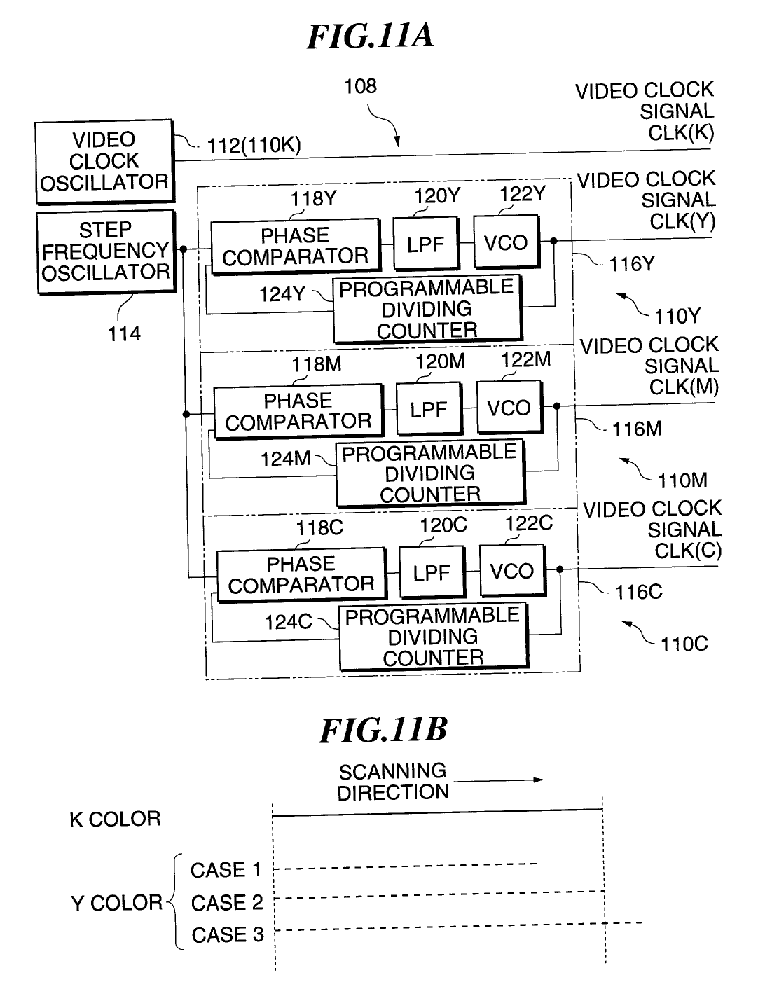

As shown in FIG. 11A, a video clock generator 110K for generating a video clock signal CLK(K) for K comprises a video clock oscillator 112 for oscillating a signal with a constant frequency. On the other hand, video clock generators 110Y, 110M, 110C for generating video clock signals CLK(Y), CLK(M), CLK(C) for Y, M, C comprise a single step frequency oscillator 114 and a divided frequency synthesizer 116.

The divided frequency synthesizer 116 is so constructed that a phase comparator 118, a low-pass filter (LPF) 120 and a voltage control oscillator (VCO) 122 are serially-connected to the output end of the step frequency oscillator 114, and the output (video clock signal) of the VCO 122 is input to the phase comparator 118 through a programmable frequency dividing counter 124. The frequency of the video clock signal output from the divided frequency synthesizer 116 is changed depending on a set value input from the control circuit 96 to the programmable frequency dividing counter 124.

That is, when the set value is made smaller, the oscillation frequency (frequency of a video clock signal) of the VCO 122 is balanced in the state of being lower than the state before the set value is changed, and when the set value is made higher, the frequency of the video clock signal is balanced in the state of being raised higher than the state before the set value is changed. The video clock signal is a signal for regulating the modulation timing of every dot, so that the change in the frequency of the video clock signal will change the dot interval in the main scanning direction, and change the scaling factor (the recording range length in the main scanning direction by laser beam).

Accordingly, as compared with the recording range length in the main scanning direction by the laser beam K, as shown in the case 1 in FIG. 11B, in the case where the recording length in the main scanning direction by the laser beam Y is smaller (the scaling factor is small), for example, the recording length (scaling factor) can be equalized as shown in case 2 by making smaller the value of data (called scaling factor set data VDATA) set in the programmable frequency dividing counter 124. Further, as shown in the case 3 in FIG. 11B, for example, in the case where the recording length in the main scanning direction by the laser beam Y is larger than that by the laser beam K (the scaling factor is larger), the recording length (scaling factor) can be equalized by making larger the value of the scaling factor set data.

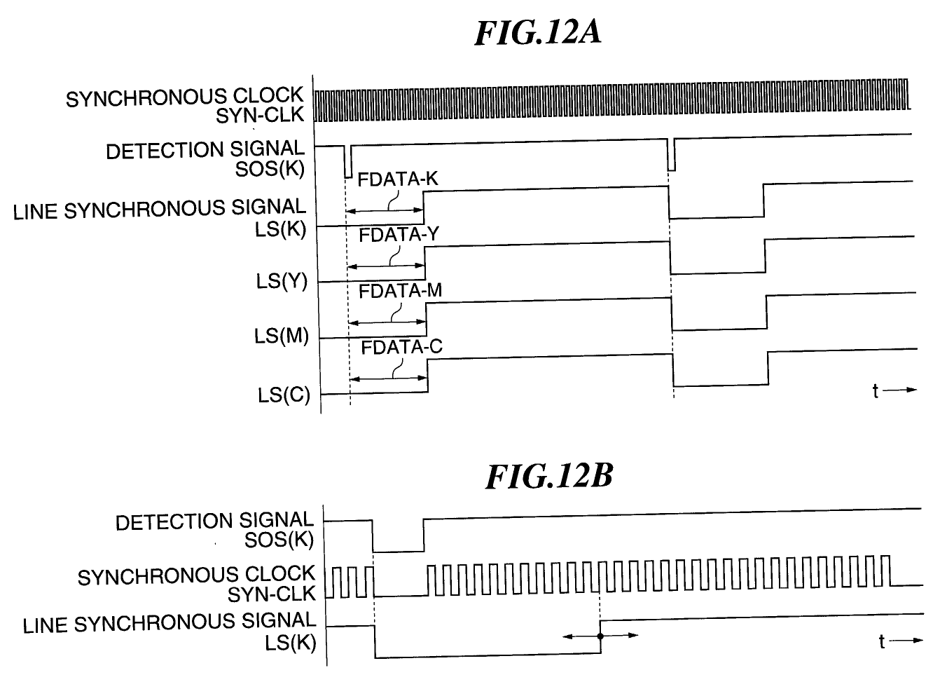

The write timing control circuit 98 comprises a synchronous clock generator 126, a line start control circuit 128, a page start control circuit 130 and four AND circuits 132. A video clock signal CLK(K) with a constant frequency is input from the video clock generator 110K to the synchronous clock generator 126, and a detection signal SOS(K) is also input thereto from the main scanning position detecting sensor 64K. According to the input signals, a synchronous clock signal SYN-CLK (see FIG. 12B) is generated and output.

The line start control circuit 128 comprises four sets of circuit groups including a counter circuit 134, an OR circuit 136 and a flip-flop circuit 138 provided corresponding to four colors of K, Y, M, C, wherein according to a detection signal SOS(K), a synchronous clock signal SYN-CLK and line sink set data held in the main controller 100, concerning each of four laser beams emitted from each LD 36, a line synchronous signal LS showing the timing of starting the modulation of a laser beam in one main scanning is generated for each of four colors K, Y, M, C.

That is, when the input detection signal SOS(K) enters a low level, the counter circuit 134 takes the line sink set data as a count value from the main controller 100, and decrements the count value in the timing synchronized with the synchronous clock SYN-CLK. When the count value becomes 0, a pulse signal is output. This pulse signal is input to the flip-flop circuit 138 through the OR circuit 136, and the level of the output signal (line synchronous signal LS) from the flip-flop circuit 138 is switched taking the pulse signal as a trigger (see FIG. 12A).

Thus, the timing of switching the level of a line synchronous signal LS (corresponding to the timing of starting the modulation of a laser beam in one main scanning) is changed as shown by an arrow in FIG. 12B according to the value of the line sink set data (expressed by FDATA in FIG. 12A) taken in the counter circuit 134. According to the change of the timing, the side registration position changes.

Similarly to the line start control circuit 128, the page start control circuit 130 also comprises four sets of circuit groups including a counter circuit 140, an OR circuit 142 and a flip-flop circuit 144 provided corresponding to four colors of K, Y, M, C. A trigger signal TOP for determining the timing of starting to transport a transfer material 28 to the transfer belt 14 is input to the page start control circuit 130, and according to the detection signal SOS(K), the trigger signal TOP and the page sink set data held in the main controller 100, concerning each of four laser beams emitted from each LD 36, a page synchronous signal PS indicating the timing of starting the modulation of a laser beam in laser beam scanning for one page is generated for each of four colors K, Y, M, C.

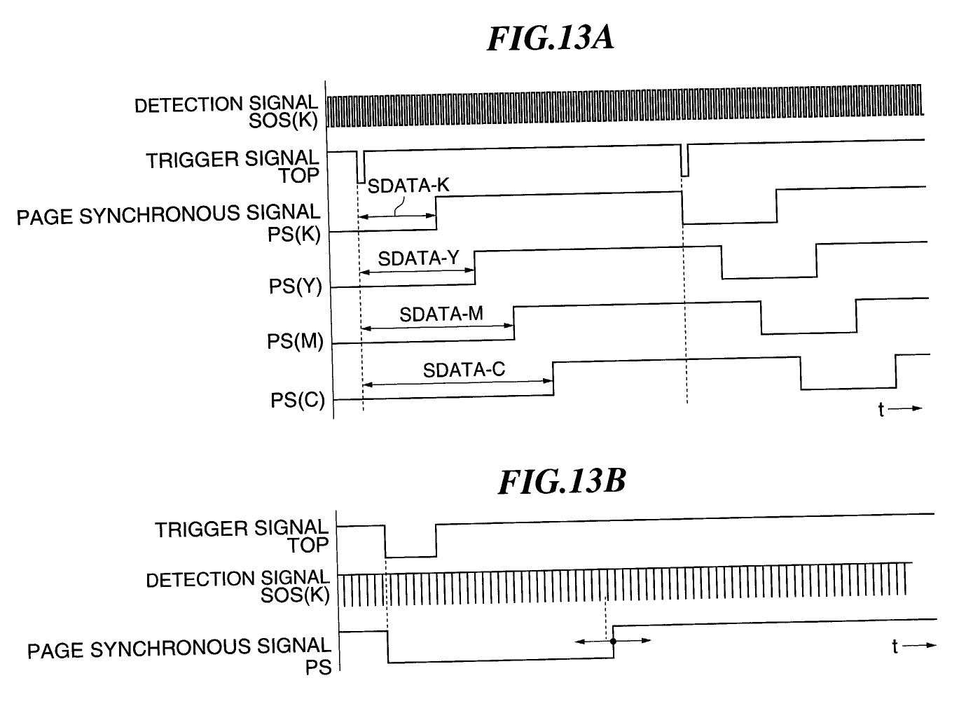

That is, when the trigger signal TOP enter a low level, the counter circuit 140 takes the page sink set data as a count value from the main controller 100, and decrements the count value in the timing synchronized with the detection signal SOS (K). When the count value becomes 0, a pulse signal is output. This pulse signal is input to the flip-flop circuit 144 through the OR circuit 142, and the level of the output signal (page synchronous signal PS) from the flip-flop circuit 144 is switched taking the pulse signal as a trigger (see FIG. 13A) . The lead registration position also changes according to this timing.

Thus, the timing of switching the level of the page synchronous signal PS (corresponding to the timing of starting the modulation of a laser beam in laser beam scanning for one page) is changed as indicated by an arrow in FIG. 13B in units of one line according to the value of the page sink set data (expressed by SDATA in FIG. 13A) taken in the counter circuit 140.

An AND circuit 132 is connected to the line start control circuit 128 and the page start control circuit 130, respectively to output a synchronous signal SYN corresponding to the AND of a line synchronous signal LS with a page synchronous signal PS for each of four colors of K, Y, M, C.

An LD modulation and driving circuit 146 is connected to the write timing control circuit 98, and the synchronous signals SYN(K), SYN(Y), SYN(M), SYN(C) corresponding to the respective colors are input to the LD modulation and driving circuit 146. Further, the LD modulation and driving circuit 146 is connected to the video clock generating device 108, and the video clock signals CLK(K), CLK(Y), CLK(M), CLK(C) corresponding to the respective colors are input to the circuit. Further, the color image data where a color image to be formed on the transfer material 28 is separated into four colors K, Y, M, C and expressed is input to the LD modulation and driving circuit 146.

The LD modulation and driving circuit 146 controls the drive of each LD 36 in such a manner that the laser beam modulated according to the image data corresponding to the same color is emitted in the timing synchronized with the video clock signal CLK corresponding to the same color within the period regulated by the synchronous signal SYN corresponding to the same color from each of the respective LDs 36K, 36Y, 36M, 36C. Thus, the laser beams are respectively emitted from the LDs 36, and the emitted laser beams are respectively deflected with the rotation of the rotary polygon mirror 34 to be scanned on the photoreceptor drums 18K, 18Y, 18M, 18C, respectively.

As the operation of the embodiment, the color aberration correction (operation and processing) for a color image formed by the image forming apparatus 10 will now be described in order.

The first color aberration is performed (1) in manufacturing and assembling the plural beam scanner 30, and the correction items to be executed at this time are (1-1) the lead registration, (1-2) the inclination of a scanning line, and (1-3) the bend of a scanning line. The correction for lead registration (1-1) is an adjusting operation necessarily performed generally in assembling an optical system, for adjusting the position and the attitude of optical parts such as a reflecting mirror or the like constructing the optical system of the plural beam scanner 30 to put the optical alignment to the nominal state. The correction of the lead registration (1-1) corresponds to coarse adjustment for the lead registration in the embodiment, and also has the operation of making the lead misregistration fall within the controllable range prior to the fine adjustment for the lead registration mentioned later.

The correction for the inclination of a scanning line (1-2) is such that concerning four laser beams emitted from the scanner 30, the direction and the degree of inclination of the scanning locus is measured by a test and measuring device (not shown) of the scanner 30 and simultaneously the adjust screw 90 is operated to control the angle of the holder 76 of the cylindrical mirror 48, thereby correcting the inclination of the scanning locus of the laser beam. Further, the correction for the inclination of a scanning line (1-2) also corresponds to the coarse adjustment for the inclination of the scanning line in the embodiment.

The correction for the bend of a scanning line (1-3) is such that concerning four laser beams emitted from the scanner 30, the direction and the degree of the bend of a scanning locus are respectively measured by a test and measuring device (not shown) of the scanner 30, and simultaneously the adjust screw 92 is operated to control the flexing amount of the cylindrical mirror 48, thereby correcting the inclination of the scanning locus of the laser beam. The correction for the bend of a scanning line (1-3) corresponds to the fine adjustment for the bend of the scanning line in the embodiment, and after the scanner 30 is manufactured and assembled, the adjustment for the bend of a scanning line is not executed.

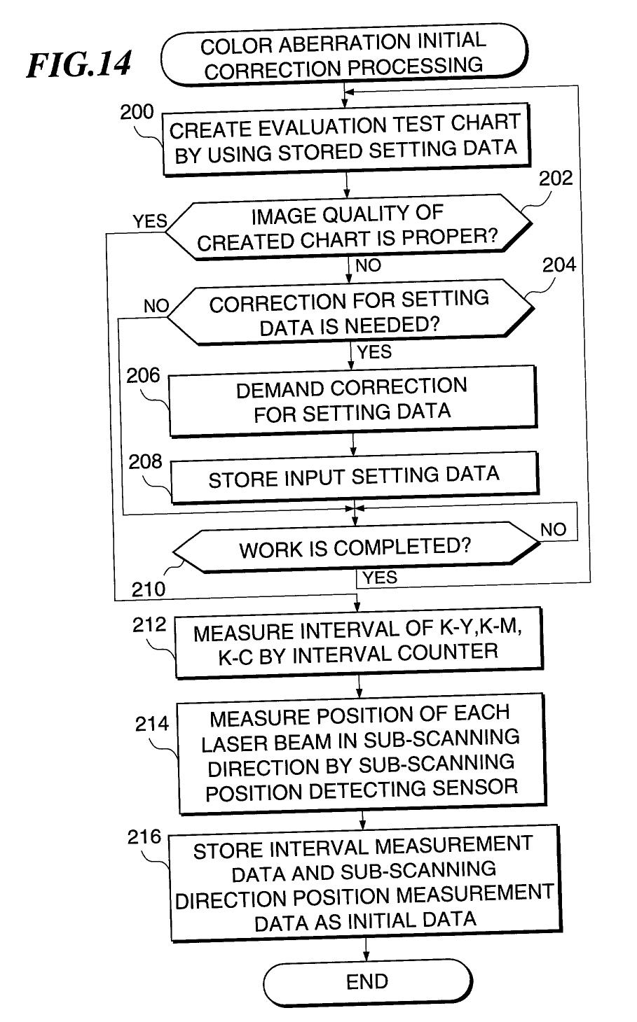

The next color aberration correction is performed (2) in loading the image forming apparatus 10 with the plural beam scanner 30, and the correction items to be executed at this time are (2-1) side registration, (2-2) lead registration, (2-3) scaling factor, and (2-4) the inclination of a scanning line. The correction for the respective items of (2-1) to (2-4) will now be described with reference to a flowchart for the color aberration correction processing shown in FIG. 14.

In the step 200, an evaluation test chart for evaluating the degree of color aberration is created. In creating the evaluation test chart, the image data of a test chart image previously stored in a first storage unit 100A such as ROM is taken, various kinds of set data (line sink set data FDATA(K), FDATA(Y), FDATA(M), FDATA(C), page sink set data SDATA(K), SDATA(Y), SDATA(M), ADATA(C) and scaling factor set data VDATA(K), VDATA(Y), VDATA(M), VDATA(C)) for regulating the modulation timing of each laser beam stored in a second nonvolatile storage unit 100B capable of rewriting the storage contents such as EEPROM is taken, and in a designated timing corresponding to the taken set data, each LD 36 is driven to modulate each laser beam according to the image data of the test chart image.

When the image forming apparatus 10 is loaded with the plural beam scanner 30 and first the processing of the step 200 is conducted, the default value or the like is set as the set data of various kinds in the second storage unit 100B.

Four laser beams emitted from the LDs 36 are respectively deflected by a single rotary polygon mirror 34, and emitted through the optical parts such as an fθ lens 44 (or 56) and a cylindrical mirror 48 toward the photoreceptor drum 18 to be scanned on the peripheral surface of the photoreceptor drum 28 charged by the charger 20. An electrostatic latent image of a test chart image formed on the peripheral surface of the photoreceptor drum 18 by scanning of the laser beam is developed as toner images of different colors by the developing device 22, and a color image (test chart image) formed by superposing the toner images of the respective colors on the belt surface of the transfer belt 14 is transferred to the transfer material 18. The transfer material 28 to which the test charge image is transferred is discharged to the outside of the frame of the image forming apparatus 10 through the fixing process.

In the next step 202, it is determined whether the image quality of the created test chart image is proper or not. An operator (assembling worker) visually observes the test chart image formed on the discharged transfer material 28 to examine whether the respective colors K, Y, M, C match or not concerning the respective items of (2-1) the side registration, (2-2) the lead registration, (2-3) the scaling factor and (2-4) the inclination of a scanning line (correction is needed or not) The examination results by each item are input through a control panel 106.

In the case where the correction for a specified item (or all items) is judged to be necessary by the operator, the determination of the step 202 is denied to cause the transition to the step 204, and it is determined whether any of (2-1) the side registration, (2-2) the lead registration and (2-3) the scaling factor is contained in the items judged to need the correction, that is, whether the correction for any of set data is needed or not.

In the case where the determination of the step 204 is denied, the transition to the step 210 occurs, and in the case where the determination is affirmed, the transition to the step 206 occurs, a message for asking the operator for correcting the set data corresponding to the items judged to need the correction is displayed on the control panel 106 to make the operator correct the set data. The correction for the set data corresponds to the correction for the side registration (2-1), the correction for the lead registration (2-2) and the correction for the scaling factor (2-3).

When the operator operates the control panel 106 to correct the set data, in the next step 208, the set data stored in the second storage unit 100B is updated and stored according to the set data corrected by the operator. Thus, the second storage unit 100B corresponds to the storage unit of the present invention, and the control panel 106 corresponds to the setting unit described in claim 2.

In the step 210, it is determined whether the operation conducted by the operator is completed or not to be on standby until the determination is affirmed. In the case where the inclination of a scanning line (2-4) is contained in the items judged to need the correction by the operator, in the meantime, the adjust screw 90 is operated according to the test chart image to control the angle of the holder 76 of the cylindrical mirror 48, thereby correcting the inclination of the scanning locus of the laser beam.

This operation corresponds to the correction for the inclination of a scanning line (2-4), and by the correction, the fine adjustment for the inclination of a scanning line in the embodiment is performed. It is clear from FIG. 3 that since the adjust screw 90 is exposed to the outside of the casing 32 of the plural beam scanner 30, it is not necessary to conduct a complicated work such as removal of the cover 50 to expose the interior of the casing 32 in conducting the adjustment work so as to save labor in the adjustment work.

When the determination of the step 210 is affirmed, it returns to the step 200. Accordingly, the correction (correction for the set data and control for the adjust screw 90) for the items judged to need the correction and regeneration of the evaluation test chart are repeated until the determination of the step 202 is affirmed (that is, until (2-1) the side registration, (2-2) the lead registration, (2-2) the scaling factor and (2-4) the inclination of a scanning line are completely corrected).

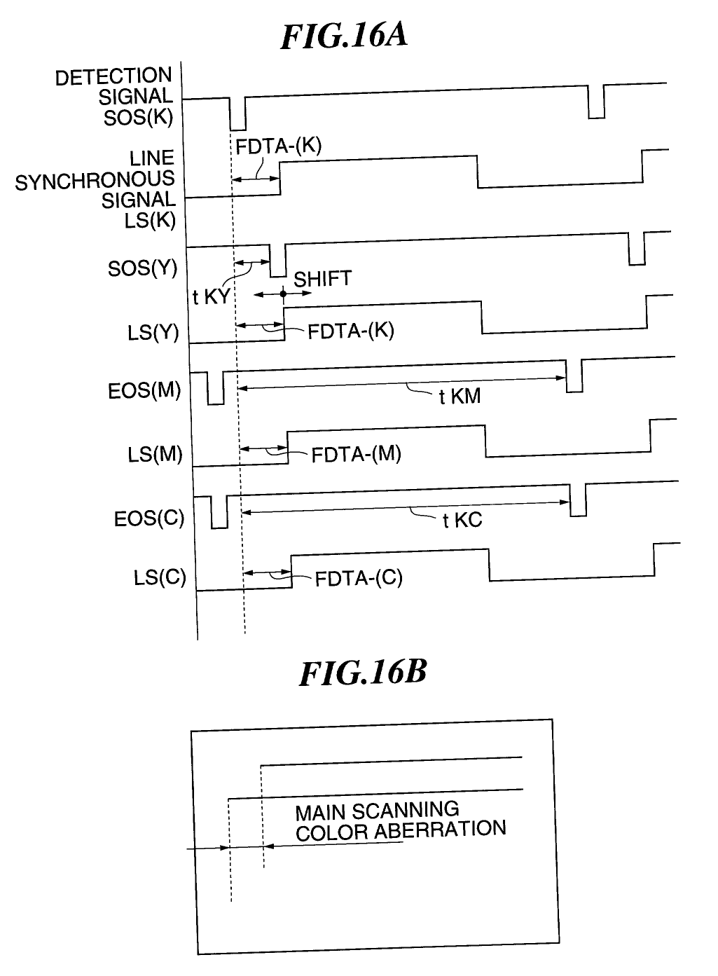

When the determination of the step 202 is affirmed, the color aberration correction is ended to cause the transition to the step 212, and in the step 212 and the following steps, the current state is stored. That is, in the step 212, on the basis of the timing of detecting the laser beam K by the main scanning position detecting sensor 64K, a difference t_{KY} from the timing of detecting the laser beam Y by the main scanning position detecting sensor 64Y, a difference t_{KM} from the timing of detecting the laser beam M by the main scanning position detecting sensor 64M, and a difference t_{KC} from the timing of detecting the laser beam C by the main scanning position detecting sensor 64C are measured (see FIG. 16A).

The measurement of a difference (interval) in timing can be realized by sequentially selecting the detection signals input to an interval counter 104 among the detection signals SOS(Y), EOS(M), OS(C) output from the main scanning position detecting sensors 64Y, 64M, 64C by a selector 102, and counting the number of pulses of the synchronous clock SYN-CLK between the intervals by the interval counter 104.

Further, in the next step 214, the sub-scanning direction positions of the laser beams K, Y, M, C are measured by the sub-scanning position detecting sensors 66K, 66Y, 66M, 66C. In the next step 216, the interval measurement results in the step 212 (interval measurement data IDATA(KY), IDATA(KM), IDATA(KC) and the beam sub-scanning direction position measurement results in the step 214 (sub-scanning direction position measurement data PDATA(K), PDATA(Y), PDATA(M), PDATA(C) are stored as the initial data in the second storage unit 100B to end the color aberration initial correction processing.

By the color aberration correction, concerning the respective items of the side registration, the lead registration, the scaling factor, the inclination of a scanning line and the bend of a scanning line, the color aberration is corrected to enable shipment as the image forming apparatus 10. In the shipped image processor 10, the inclination of the scanning line and the bend of the scanning line are corrected by the adjust screws 90, 92, and each laser beam is modulated in a designated timing corresponding to the set data set by the preceding color aberration initial correction processing to form a color image, so that the side registration , the lead registration and the scaling factor of each color match.

The arrangement positions of optical parts constructing the plural beam scanner 30 are changed by the change of ambient temperature of the image forming apparatus 10 or a temperature rise in the interior of the image forming apparatus 10 due to continuation of the operating condition. Therefore, the color aberration correction is steadily performed (3) even during the normal time (operation time) after the image forming apparatus 10 is shipped (e.g. within the standby period the image formation is not performed during the operation). At this time, the correction items to be executed are (3-1) the side registration and (3-2) the lead registration.

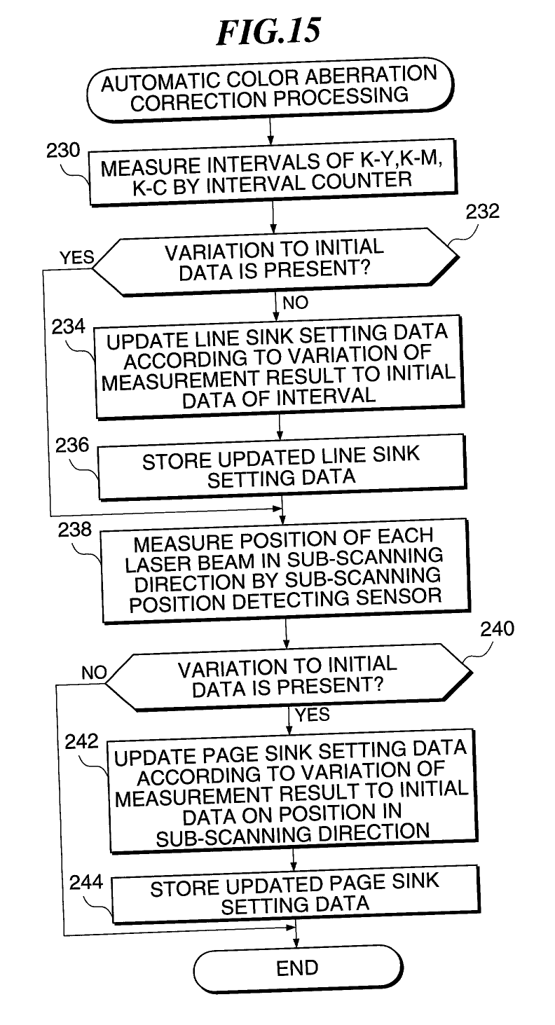

The correction for both items of (3-1) and (3-2) will now be described with reference to a flowchart of automatic color aberration correction processing shown in FIG. 15. In the step 230, similarly to the step 212 of the previously described color aberration initial correction processing (FIG. 14), the intervals t_{KY}, t_{KM} and t_{KC} are measured by the interval counter 104. In the next step 23, it is determined whether or not the interval measured in the step 230 is varied from the interval indicated by the interval measurement data stored as the initial data in the second storage unit 100B. The determination corresponds to “the detection of variation in positional relationship between the light beams” by the detecting unit of the present invention. Since the variation is detected by comparison with the initial data, it also corresponds to the detecting unit described in claim 4. In the case where the determination of the step 232 is denied, the transition to the step 238 occurs without any processing.

On the other hand, as the set data for regulating the modulation timing of a laser beam is not yet changed, in the case where the measurement value of the interval is varied, there is the possibility that the side misregistration by each color is caused (see “main scanning color aberration” shown in FIG. 16B) by a change in the arrangement position of the optical part constructing the plural beam scanner 30. Therefore, in the case where the determination of the step 232 is affirmed, the transition to the step 234 occurs to update the line sink set data according to the variation in the interval measurement result measured in the step 230. The step 234 corresponds to the correcting unit of the present invention (to be more precise, the correcting unit described in claim 5 and claim 6).

The line sink set data can be updated by changing the side registration position of another color on the basis of K to update the line sink set data FDATA(Y) on Y in the case where the interval t_{KY} is varied (in this case, the write timing by the laser beam Y is changed as expressed by “shift” in FIG. 16A). In the next step 236, the updated line sink set data is stored in the second storage unit 100B.

The processing corresponds to the correction for the side registration (3-1), and the side registration is automatically corrected by the feedback control. Thus, the modulation of the laser beam in the subsequent image forming process is performed in the timing corresponding to the updated line sink set data, so that the side misregistration by each color can be prevented regardless of a variation in temperature.

The timing of switching the line synchronous signal LS is changed taking one cycle of a synchronous clock SYN-CLK as a unit to the change in the value of the line sink set data FDATA, so that the minimum unit of correction for the side registration corresponds to a dot pitch in the main scanning direction, and it is needless to say that when the cycle of the synchronous clock SYN-CLK is made smaller (the frequency is made higher), the side registration can be adjusted more finely.

In the next step 238, similarly to the step 214 of the previously described color aberration initial correction processing (FIG. 14), the sub-scanning direction positions of the laser beams K, Y, M, C are measured by the sub-scanning position detecting sensors 66K, 66Y, 66M, 66C. In the next step 240, it is determined whether or not the sub-scanning direction positions of the respective laser beams measured in the step 238 are varied with respect to the sub-scanning direction position indicated by the sub-scanning direction position measurement data stored as the initial data in the second storage unit 100B. The determination also corresponds to “the detection of a variation in positional relationship between the light beams ” by the detecting unit of the present invention, and as the variation is detected by comparison with the initial data, it corresponds to the detecting unit described in claim 4. In the case where the determination of the step 240 is denied, the automatic color aberration correction processing is ended.

On the other hand, in the case where the measurement value of the sub-scanning direction position varies, there is the possibility that the lead misregistration by each color is caused by the change in the arrangement position of the optical part constructing the plural beam scanner 30. Therefore, in the case where the determination of the step 240 is affirmed, the transition to the step 242 occurs to update the page sink set data according to the variation in the sub-scanning direction position measured in the step 238 to the sub-scanning direction position indicated by the initial data. The step 242 corresponds to the correcting unit of the present invention (to be more precise, the correcting unit described in claim 5 and claim 6).

The page sink set data can be updated by operating a difference (the shifting amount in the sub-scanning direction of the scanning line of a laser beam of a designated color to the scanning line to the laser beam K) in variation amount of the sub-scanning direction position concerning a laser beam of a designated color on the basis of the variation amount of the sub-scanning direction position concerning the laser beam K, for example, and changing the lead registration position of another color on the basis of K to update the page sink set data SDATA of a designated color only by the value obtained by dividing the arithmetic result by the scanning line interval in the sub-scanning direction. In the next step 244, the updated line sink set data is stored in the second storage unit 100B.

The processing corresponds to the correction for the lead registration (3-2), and the lead registration is automatically corrected by the feedback control. Thus, the modulation of a laser beam in the subsequent image formation processing is performed in the timing corresponding to the updated page sink set data, so that the lead misregistration by each color can be prevented regardless of a variation in temperature.

The processing according to an output signal from the sub-scanning position detecting sensor 66 is shown in a block diagram of FIG. 5C. That is, the sub-scanning position detecting sensor (PSD) 66 outputs a signal of voltage level corresponding to the laser beam incident position (sub-scanning direction) on the PSD 66, and the signal is amplified by an amplifier 172 to be input to a voltage comparator 174. The set voltage V input to the voltage comparator 174 is the voltage in the case where when a laser beam is incident on an expected position, a signal output from the PSD 66 is amplified by the amplifier 172, and a signal corresponding to a shift in the incident position of the laser beam to the expected incident position is output from the voltage comparator 174. The output is converted to the digital data by an A/D converter 176 to be used in operating the correction value in a sub-scanning arithmetic circuit 178.

In the case where the environment where the image forming apparatus 10 is installed is remarkably changed or the relative position among the photoreceptor drums 18K, 18Y, 18M and 18C is considerably changed, even if the automatic color aberration correction processing is conducted, the color aberration cannot be eliminated so as to prevent deterioration of image quality. As described above, when (4) the image quality is deteriorated, the previously described color aberration initial correction processing (FIG. 14) is again executed to make the correction for the respective items of (4-1) the side registration, (4-2) the lead registration, (4-3) the scaling factor, and (4-4) the inclination of a scanning line.

In the embodiment, during the operation of the image forming apparatus 10, the automatic color aberration correction processing is steadily performed, so that the frequency of requiring execution of the color aberration correction due to the deterioration of image quality can be remarkably lowered. The corrections for the color aberration in each time described above are summarized in the following table 1.

TABLE 1

| | | (2) | CORRECTION AFTER SHIPMENT OF | |
|---|---|---|---|---|
| | | CORRECTION IN | APPARATUS | |
| | (1) | MOUNTING | | (4) |
| | CORRECTION IN | SCANNER IN | | DETERIORATION |
| | ASSEMBLING | IMAGE FORMING | | OF IMAGE |
| | SCANNER | APPARATUS | (3) NORMAL | QUALITY |
| SIDE | | (2-1) SETTING | (3-1) | (4-1) SETTING |
| REGISTRATION | | OF LINE SINK | FEEDBACK | OF LINE SINK |
| | | SET DATA | CONTROL | SET DATA |
| LEAD | (1-1) | (2-2) SETTING | (3-2) | (4-2) SETTING |
| REGISTRATION | ADJUSTMENT BY | OF PAGE SINK | FEEDBACK | OF PAGE SINK |
| PAGE | ADJUST SCREW | SET DATA | CONTROL | SET DATA |
| | (COARSE | | | |
| | ADJUSTMENT) | | | |
| SCALING | | (2-3) SETTING | | (4-3) SETTING |
| FACTOR | | OF SCALING | | OF SCALING |
| | | FACTOR SET | | FACTOR SET |
| | | DATA | | DATA |
| INCLINATION | (1-2) | (2-4) | | (4-4) |
| OF SCANNING | ADJUSTMENT BY | ADJUSTMENT BY | | ADJUSTMENT BY |
| LINE | ADJUST SCREW | ADJUST SCREW | | ADJUST SCREW |
| | (COARSE | (FINE | | (FINE |
| | ADJUSTMENT) | ADJUSTMENT) | | ADJUSTMENT) |
| BEND OF | (1-3) | | | |
| SCANNING LINE | ADJUSTMENT BY | | | |
| | ADJUST SCREW | | | |
| | (COARSE/FINE | | | |
| | ADJUSTMENT) | | | |
| DATA USED FOR | OUTPUT OF | EVALUATION | SENSOR OUTPUT | EVALUATION |
| CORRECTION | TEST | TEST CHART | IN SCANNER | TEST CHART |
| | MEASURING | | | |
| | DEVICE | | | |

In the above embodiment, the modulation timing is controlled on the basis of K among the colors K, Y, M, C, but it is needless to say that the processing may be conducted on the basis of another color.

Though the bend of a scanning line is corrected in assembling the scanner 30 in the above embodiment, this is not restrictive, and it is needless to say that the bend of the scanning line may be corrected even after the scanner 30 is assembled. Especially, the scanner 30 related to the embodiment is so constructed that the adjust screw 92 for correcting the bend of a scanning line is exposed so as to easily correct the bend of a scanning line.

Though the control panel is described as the setting unit described in claim 2 in the embodiment, this is not restrictive, and a keyboard or a portable terminal separable from the image forming apparatus main body or a small-sized self-diagnosing device can be used as a setting unit.

Further, though the side registration (relative misregistration in the light beam scanning direction of plural images) is corrected by setting and updating the line sink set data to vary the modulation start timing of each laser beam in the main scanning direction of the laser beam (modulation timing of each light beam; to be more precise, it corresponds to the modulation start time within the period of one scan of each light beam) in the above, the correction for the side registration is not limited to the above. For example, memories for storing image data by each color of K, Y, M, C are provided corresponding to the respective colors (the storage area of a single memory may be divided to correspond to the respective colors), an address in storing the image data of each color showing a color image to be formed on the transfer material 28 in the memory is relatively shifted in the direction corresponding to the scanning direction of a laser beam according to the side registration correction amount obtained by examining the side registration to a test chart image, or the variation of an interval measured by the interval counter 104 (among the image areas of each memory, the area where the image data is not stored may be filled up with data of such a value that substantially a laser beam is not emitted from the LD 36 when it is used in modulating the LD 36; the same with every kind of correction to be mentioned later), and in modulating four laser beams, by simply reading out the data in order from each memory and inputting the same to the LD modulation driving circuit 146, the side registration may be corrected without changing the modulation start timing of each laser beam in the main scanning direction. The processing corresponds to “the operation of image data used in modulating a light beam”.

Further, though the lead registration (relative misregistration in the direction intersecting the light beam scanning direction of plural images) is corrected by setting and updating the page sink set data to vary the modulation start timing of each laser beam in the sub-scanning direction of the laser beam (the modulation timing of each light beam; to be more precise, it corresponds to the modulation start time taking one scan of each light beam as a unit) in the above, the correction for the lead registration is not limited to the above, either. For example, memories for storing image data are provided corresponding to the respective colors, an address in storing the image data of each color showing a color image to be formed on the transfer material 28 in the corresponding memory is relatively shifted in the direction corresponding to the sub-scanning direction of a laser beam according to the lead registration correction amount obtained by examining the lead registration to a test chart image, or the variation of the sub-scanning direction position of each laser beam detected by the sub-scanning position detecting sensor 66, and in modulating four laser beams, by simply reading out the data in order from each memory and inputting the same to the LD modulation driving circuit 146, the lead registration may be corrected without changing the modulation start timing of each laser beam in the sub-scanning direction. The processing also corresponds to “the operation of image data used in modulating a light beam”.

Though the scaling factor (relative size difference in the light beam scanning direction of plural images) is corrected by setting the scaling factor set data and varying the frequency of a video clock signal to change the dot interval in the main scanning direction (modulation timing of each light beam, to be more precise, the modulation time length within the period of one scan of a light beam) in the above, the correction for the scaling factor is not limited to the above. For example, memories for storing image data are provided corresponding to the respective colors, image data of each color showing a color image to be formed on the transfer material 28 is enlarged or reduced in the direction corresponding to the main scanning direction of a laser beam according to the scaling factor correction amount obtained by examining the scaling factor to a test chart image, and then stored in the corresponding memory, and in modulating four laser beams, by simply reading out the data in order from each memory and inputting the same to the LD modulation driving circuit 146, the scaling factor may be corrected without changing the length of modulation time within the period of one scan of a laser beam. The processing also corresponds to “the operation of image data used in modulating a light beam”.

Further, though the inclination of a scanning locus of a laser beam is corrected by rotating the adjust screw 90 to turn the cylindrical mirror 48 on the steel ball 78, and the inclination of a scanning locus of a laser beam is corrected by rotating the adjust screw 90 to turn the cylindrical mirror 48 on the steel ball 78 in the above, the correction for the inclination and the bend of a scanning locus is not limited to the above, either. For example, memories for storing image data are provided corresponding to the respective colors, the image data of each color showing a color image to be formed on the transfer material 28 is geometrically converted to cancel the inclination and the bend of the scanning locus according to the inclination amount and the bend amount of the scanning locus obtained by examining the inclination and the bend of the scanning locus to a test chart image and then stored in the memory, and in modulating four laser beams, by simply reading out the data in order from each memory and inputting the same to the LD modulation driving circuit 146, the inclination and the bend of the scanning locus may be corrected without adjustment of the mechanical position or attitude such as turning of the cylindrical mirror 48 or change of the deflection amount. Further, instead of geometrically converting the image data as described above, the read-out address in reading out the data from the memory and outputting the same to the LD modulation driving circuit 146 may be sequentially shifted according to the inclination amount of the scanning locus, or sequentially changed according to the bend amount of the scanning locus. Also the above processing corresponds to “the operation of image data used in modulating a light beam”.

Further, though the above description deals with the case of implementing the correction for the side registration, the lead registration and the scaling factor by the electric control, this is not restrictive, and the correction may be realized by the mechanical adjustment. That is, the side registration can be adjusted and corrected by varying the amount of time between when an SOS signal is input and when the modulation of a light beam is started, the lead registration can be adjusted and corrected by varying the amount of time between when a signal or the like showing that the leading edge of paper is detected and when the modulation of a light beam is started, and the scaling factor can be adjusted and corrected by varying the frequency of a video clock signal. The adjustment and correction for the side registration, the lead registration and the scaling factor is the adjustment and correction made on the assumption of the state of the light beam scanner (plural beam scanner 30) in adjusting and correcting them, that is, the side registration, the lead registration and the scaling factor can be adjusted and corrected by adjusting the state of the light beam scanner without changing the modulation start timing of a light beam and the frequency of a video clock signal.

To be specific, the side registration and the lead registration are closely related to the alignment of a light beam emitted from a light beam scanner, and the scaling factor is related to the optical path length of a light beam, the change of which is incidental to the change of the alignment. As the alignment of a light beam emitted from the light beam scanner can be arbitrarily altered, for example, by adjusting the angle (or the position) of the final optical part in the light beam scanner in three dimensions, the side registration, the lead registration and the scaling factor may be corrected by making such adjustment.

Though the above description deals with the case of making correction in all of five items, namely the side registration, the lead registration, the scaling factor, the inclination of a scanning line, and the bend of a scanning line, the present invention is not limited to the case. For example, in the case where in the image forming apparatus of the present invention, specified items of the five items will exert no influence on the image quality, or the image forming apparatus of the present invention has been developed with priority to cost reduction of the apparatus, two to four items may be arbitrarily selected from the five items to make correction (compensation) only in the selected items. Thus, the apparatus cost can be reduced as compared with the case of making correction in all of the five items.

In selecting the items to be corrected, it is preferable to select them so that at least the side registration and the lead registration are included. This is because frequently the misregistration of the side edge and the leading edge is remarkably confirmed visually as deterioration of the image quality. When at least the side registration and the lead registration are corrected in the case of selectively making correction in the five items, the image quality can be efficiently improved while an increase in the apparatus cost is restrained.

According to the present invention, as described above, the image forming apparatus includes two or more compensating units selected from a first compensating unit that compensates for the relative misregistration in the light beam scanning direction on a transfer body of plural images superposed on the transfer body, a second compensating unit that compensates for the relative misregistration in the direction intersecting the light beam scanning direction of the plural images, a third compensating unit that compensates for a relative size difference in the light beam scanning direction of the plural images, a fourth compensating unit that compensates for the inclination of a scanning locus of a light beam on the transfer body, and a fifth compensating unit that compensates for the relative bend of a scanning locus of a light beam on the transfer body, so that the image quality of an output image formed by composition of plural images can be improved in a simple and low-cost constitution.

Further, according to the present invention, the modulation timing of a light beam is controlled, or the image data used in modulating a light beam is operated according to at least either a first correction data set to correct the relative misregistration in the light beam scanning direction on a transfer body of plural images superposed on the transfer body or a second correction data set to correct the relative misregistration in the direction intersecting the light beam scanning direction of the plural images, and also according to the variation in the mutual positional relationship of the light beams detected by a detecting unit, the modulation timing of the light beam is controlled, or the operation for the image data used in modulating the light beam is corrected, so that the image quality of an output image formed by composition of plural images can be improved.

What is claimed is:

1. An image forming apparatus, which has a plurality of photoreceptors, and is adapted to form images on the respective photoreceptors by scanning the photoreceptors with plural light beams, respectively, and sequentially transfer the plural images to a transfer body in such a manner that the plural images formed on the respective photoreceptors are superposed one another to form a single image on the transfer body, comprising at least two compensating units from among:
a first compensating unit that compensates for a relative misregistration of the plural images on the transfer body in the light beam scanning direction;
a second compensating unit that compensates for a relative misregistration of the plural images on the transfer body in the direction intersecting the scanning direction;
a third compensating unit that compensates for a difference in relative size between plural images on the transfer body in the scanning direction;
a fourth compensating unit that compensates for relative inclination of scanning loci of light beams on the transfer body; and
a fifth compensating unit for compensating for a relative bend of scanning loci of light beams on the transfer body.

2. The image forming apparatus according to claim 1, wherein the apparatus comprises at least the first compensating unit and the second compensating unit.

3. The image forming apparatus according to claim 1, wherein the apparatus comprises all of the first compensating unit to the fifth compensating unit, and each of the first compensating unit to the fifth compensating unit is adapted to perform the compensation by controlling a modulation timing of the light beam, controlling the operation of image data used in modulating the light beam, or adjusting the position or the attitude of an optical part for guiding the light beam to the photoreceptor.

4. An image forming apparatus, which has a plurality of photoreceptors, and is adapted to form images on the respective photoreceptors by scanning the photoreceptors with plural light beams, respectively, and sequentially transfer the plural images to a transfer body in such a manner that the plural images formed on the respective photoreceptors are superposed one another to form a single image on the transfer body, comprising:
a control unit that controls a modulation timing of the light beam or operating image data used in modulating the light beam according to at least one of first correction data set to correct a relative misregistration of the plural images on the transfer body in the light beam scanning direction and second correction data set to correct a relative misregistration of the plural images on the transfer body in the direction intersecting the scanning direction;
a detecting unit that detects a variation in positional relationship between the light beams; and
a correcting unit that corrects the control for the modulation timing of the light beam by the control unit or the operation of image data used in modulating the light beam according to the variation in the positional relationship between the light beams detected by the detecting unit.

5. The image forming apparatus according claim 4, further comprising:
a storage unit that stores at least one of a modulation start time within the period of one scan with each light beam as the first correction data set to correct the relative misregistration of the plural images on the transfer body in the light beam scanning direction and a modulation start time taking one scan with each light beam as a unit as the second correction data set to correct the relative misregistration of the plural images on the transfer body in the direction intersecting the scanning direction,
wherein the control unit controls the modulation of each light beam in the modulation timing corresponding to the modulation start time stored in the storage unit, and the correcting unit corrects the modulation timing of a light beam according to the variation in the positional relationship between the light beams detected by the detecting unit.

6. The image forming apparatus according to claim 5, further comprising:
an adjusting unit capable of adjusting a relative inclination and a bend of scanning loci of the light beams on the respective photoreceptors taking the individual beams as a unit,
wherein the storage unit stores the modulation start time within the period of one scan with each of the light beams, the modulation start time taking one scan with each of the light beams as a unit, and the length of the modulation time within the period of one scan with each light beam set to correct a difference in relative size of plural images in the scanning direction, and the control unit controls the modulation of each light beam in the modulation timing corresponding to the modulation start time and the length of the modulation time stored in the storage unit.

7. The image forming apparatus according to claim 6, further comprising:
a setting unit that sets the modulation start time within the period of one scan with each light beam to correct the relative misregistration of the plural images in the light beam scanning direction in the storage unit, sets the modulation start time taking one scan with each light beam as a unit to correct the relative misregistration of the plural images in the direction intersecting the scanning direction in the storing unit, and sets the length of the modulation time within the period of one scan with each light beam to correct a difference in the relative size of the plural images in the scanning direction in the storage unit.

8. The image forming apparatus according to claim 6, wherein the detecting unit comprises a passing detecting unit that detects the passing of a light beam at a designated position within a light beam scanning range concerning the respective light beams, and a position detecting unit that detects the scanning position of each light beam in the direction intersecting the scanning direction of a light beam, and the detecting unit is adapted to detect the positional relationship between the respective light beams in the scanning direction according to the timing of detecting the passing of each light beam by the passing detecting unit, and to detect the positional relationship between the respective light beams in the direction intersecting the scanning direction according to the scanning position of each light beam detected by the position detecting unit.

9. The image forming apparatus according to claim 6, wherein the detecting unit detects the positional relationship between the light beams and stores the same, detects the positional relationship between the respective light beams, and compares the detected positional relationship with the stored positional relationship to detect a variation in the positional relationship.

10. The image forming apparatus according to claim 6, wherein the detecting unit detects a variation in the positional relationship between plural light beams in the scanning direction of a light beam and in the direction intersecting the scanning direction, respectively, and the correcting unit corrects the modulation start time within the period of one scan with each light beam in the case where a variation in the positional relationship between the respective light beams in the scanning direction is detected, and corrects the modulation start time taking one scan with each light beam as a unit in the case where a variation in the positional relationship between the respective light beams in the direction intersecting the scanning direction is detected.

11. The image forming apparatus according to claim 6, wherein the storage unit stores a first set value for regulating the modulation start time within the period of one scan with each light beam on the basis of the timing of passing of a specified light beam through a designated position within the light beam scanning range, a second set value for regulating the modulation start time taking one scan with each light beam as a unit on the basis of a designated timing, and a third set value for regulating the length of the modulation time within the period of the one scan by the frequency of a clock signal showing the modulation timing of a light beam within the period of one scan, the control unit controls the modulation of each light beam according to the first to the third set values stored in the storage unit, and the correcting unit corrects at least one of the first set value and the second set value according to the detected variation in the positional relationship between the respective stored light beams.

12. The image forming apparatus according to claim 6, wherein the adjusting unit is a manual adjusting mechanism for transmitting stress in a designated direction as the force for displacing a designated optical part constructing a scanning optical system for a light beam to change the degree of the inclination or the bend of a scanning locus of a light beam to the designated optical part when the stress in a designated direction is applied.

13. The image forming apparatus according to claim 6, wherein in the condition where a scanner including a light source for emitting each of the light beams, a deflecting unit that deflects each light beam so that each light beam scans on a photoreceptor, and a scanning optical system for guiding the deflected light beam to the photoreceptor is accommodated in a storing box to be concealed from the outside, the setting unit is capable of setting the modulation start time within the period of one scan of each light beam, the modulation start time taking one scan of each light beam as a unit, and the length of the modulation time within the period of one scan of each light beam in the storage unit, and the adjusting unit is capable of adjusting the inclination and the bend of a scanning locus of a light beam on the photoreceptor.
